(19) United States
(12) Patent Application Publication
(10) Pub. No.: US 2012/0166275 A1
(43) Pub. Date: Jun. 28, 2012

(54) PRIVACY ENHANCING DISPLAY ADVERTISMENT RECOMMENDATION USING TAGGING

(75) Inventor: Prosenjit GUPTA, Bangalore (IN)

(73) Assignee: Yahoo! Inc, Sunnyvale, CA (US)

(21) Appl. No.: 12/977,099

(22) Filed: Dec. 23, 2010

(51) Int. Cl. G06Q 30/00

(52) U.S. Cl. 705/14.49

(57) ABSTRACT

Privacy enhancing display advertisement recommendation using tagging. A method for privacy enhancing display advertisement using tagging includes the step of displaying a first advertisement on a web page. The method also includes the step of receiving an advertisement tag from a user and selecting a second advertisement based on the advertisement tag Furthermore, the method includes the step of displaying the second advertisement.

### BACKGROUND

1. Technical Field

Embodiments of the invention relate generally to online advertisements, and more specifically, to using tags to select online advertisements.

2. Prior Art

Online advertisement is primarily used for promoting a variety of products and to deliver marketing messages to users. Generally, online advertisement are digital advertisements displayed on a web page. Further, online advertising involves selecting advertisements and displaying to the user. Many business models are based on click-throughs on an advertisement, or the number of users that are drawn enough to an online advertisement to click a related hyperlink for additional information. However, the problem of selecting advertisements that might interest the user still exists. Various techniques exist to display targeted advertisements. One such technique gathers information pertaining to various online activities, web accessed content, items purchased online and web searches performed by the user. Specific advertisements are then recommended based on the information.

However, this technique encroaches into user privacy and has created various privacy related issues to the user. Further, displaying advertisements that are not of user's interest can be cost consuming for the website publisher and advertisers.

In the light of the foregoing discussion, there is a need for an efficient technique to address user privacy concerns in targeted online advertisements.

### SUMMARY

The above-mentioned needs are met by a method, computer program product and system for selecting advertisements based on user tags.

An example of a method to display online advertisements based on tagging includes the step of displaying a first advertisement on a web page. The method also includes the step of receiving an advertisement tag from a user, the advertisement tag comprising a description of the first advertisement. Further, the method includes the step of selecting a second advertisement based on the advertisement tag. Furthermore, the method includes the step of displaying the second advertisement.

An example of a computer program product stored on a non-transitory computer-readable medium that when executed by a processor, performs a method to display online advertisements based on tagging includes the steps of displaying a first advertisement on a web page and receiving an advertisement tag from a user, the advertisement tag comprising a description of the first advertisement. Further, the computer program product includes the step of selecting a second advertisement based on the advertisement tag. Furthermore, the computer program product includes the step of displaying the second advertisement.

An example of a system to display online advertisements based on tagging includes a web interface to display a first and second advertisement on a web page. The web interface receives an advertisement tag from a user, the advertisement tag comprising a description of the first advertisement. The system also includes an advertisement selection engine, communicatively coupled to the web interface, to select a second advertisement based on the advertisement tag.

Advantageously, effective targeted advertisements are provided to a user without violating that user's privacy.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for displaying online advertisements based on tagging in accordance to an embodiment.

FIG. 2 is a flow chart illustrating a method for selecting online advertisements based on tagging in accordance to an embodiment.

FIG. 3 is a schematic representation illustrating exemplary advertisement on a web page with user-entered tag window in accordance to an embodiment.

FIG. 4A and FIG. 4B are schematic diagrams illustrating a bipartite graph and resulting table according to an embodiment.

FIG. 5 is a block diagram illustrating a system to display online advertisements based on tagging in accordance to an embodiment.

FIG. 6 is a block diagram illustrating a computing device in accordance to an embodiment.

FIG. 7 is a block diagram illustrating an ad selection server in accordance to an embodiment.

FIG. 8 is a block diagram of an advertisement selection engine in accordance to an embodiment.

### DETAILED DESCRIPTION

The above-mentioned needs are met by a method, computer program product and system for selecting advertisements based on user tags. The following detailed description is intended to provide example implementations to one of ordinary skill in the art, and is not intended to limit the invention to the explicit disclosure, as one or ordinary skill in the art will understand that variations can be substituted that are within the scope of the invention as described.

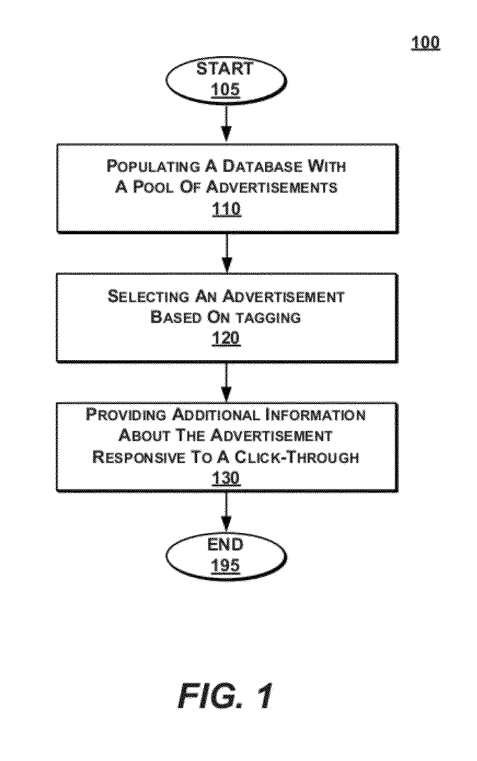

FIG. 1 is a flow chart illustrating a method 100 for displaying online advertisements based on tagging in accordance to an embodiment.

The method starts at step 105. At step 100, a database of advertisements is populated. A web page is, in one example, a document consisting of text, images, advertisements and hypertext links.

An advertisement can be stored with a pool of advertisements. Each advertisement has associated metadata describing the advertisement. The metadata can relate to content, type of product, product description, part of the country, time of day, tempo, target audience, advertising rate, and the like. The metadata can also include a unique identification tag as string of alphanumeric characters.

An advertisement can be text, an image, video or animation related to, for example, a product or a service. The advertisements represent one or more products and services. In one embodiment, the advertisement can be a click-through to a new page showing more detailed information. The advertisement can be located in a static position, or dynamically move across a web page.

At step 120, an advertisement is selected for display based on user tags. A tag generally indicates an interest, a type of interest, or a level of interest in an advertisement. As such, a tag can comprise, for example, a “Like” button (or “Don't Like” button), a number of stars, a category marker, a user-generated description, and the like.

Examples of advertisements selected responsive to tags include: a listing of gyms in the area responsive to tagging an advertisement for gym equipment; an advertisement for sunglasses responsive to tagging an advertisement for beach equipment; a list of online book stores responsive to tagging an advertisement for a movie based on a book; links to sports articles responsive to tagging an advertisement for a football game; and a list of local pet clinics responsive to tagging an advertisement for pet adoptions, among many other possibilities.

In one embodiment, a user tags one or more advertisements displayed on a web page. Metadata associated with a tag is matched to metadata associated with an advertisement in a pool of advertisements. In response, a new advertisement is selected for display.

In other embodiments, advertisements are selected and displayed in environments other then web pages. One of ordinary skill will recognize that, given the disclosure herein, the same techniques can be applied to other digital environments such as web-enabled applications other than web browsers, video games, Internet television, digital books, and the like. Thus, the present environment of web page advertisements is discussed herein only for the purpose of providing an in-depth description of an embodiment.

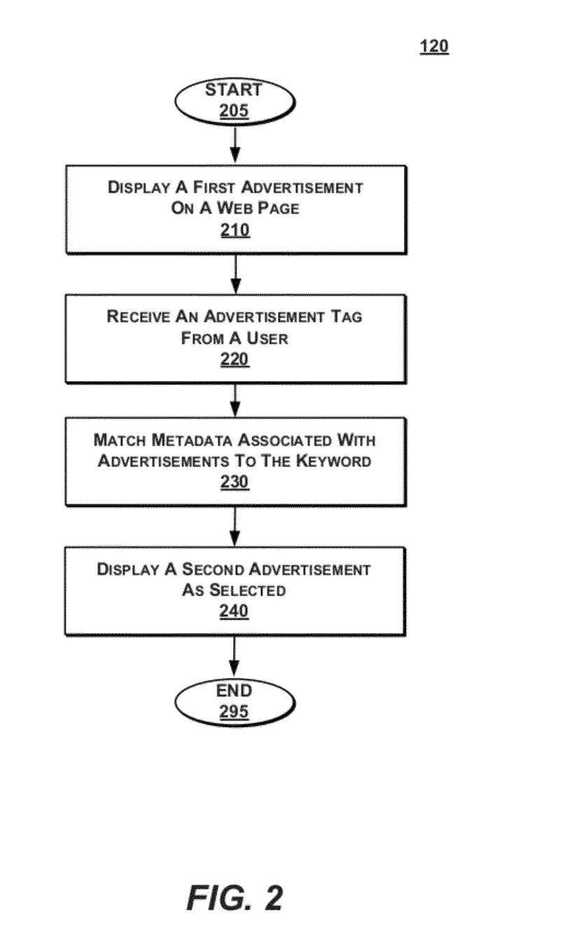

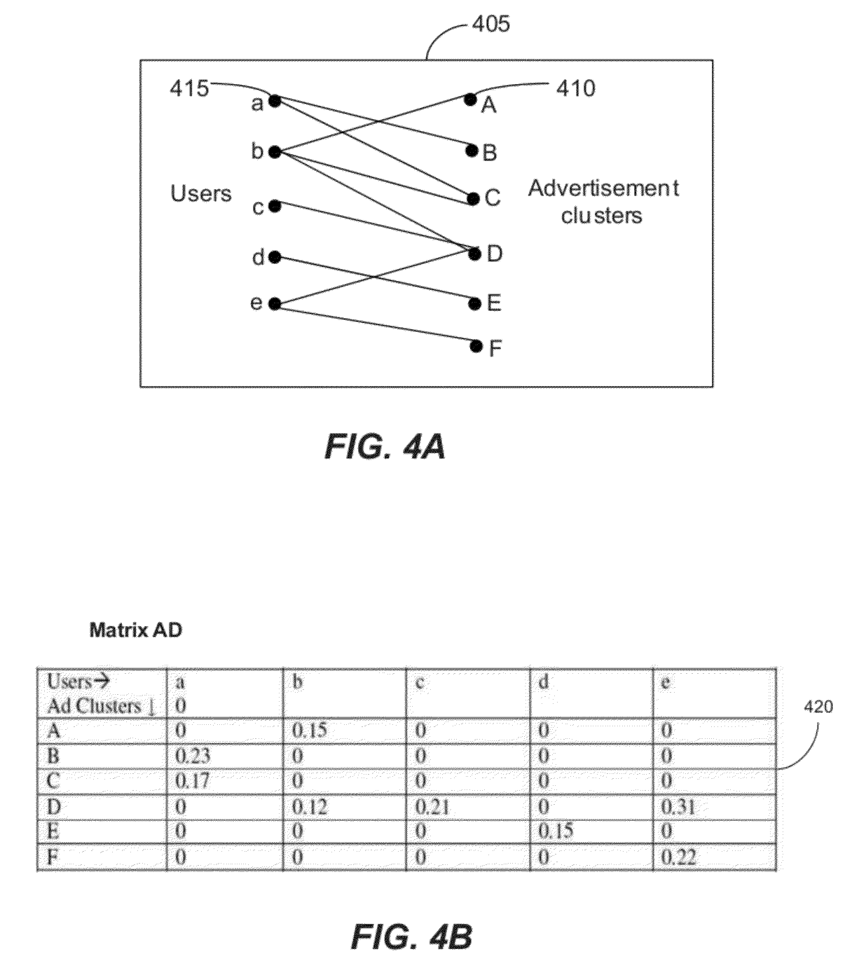

Additional embodiments for selecting advertisements are discussed below in association with FIG. 2, FIG. 4A and FIG. 4B.

At step 130, if a click-through is received, additional information about the advertisement is provided. For example, a home page for the product can be spawned in a new window, a map to a nearest location can be displayed, or a list of related products can be produced. In one embodiment, an advertiser pays a web content provider according to a number of click-throughs on their advertisements. This provides evidence to the advertiser that a user's attention has been captured. The techniques described herein for providing advertisements that are relevant to a user is likely to result in higher amounts of click-throughs.

In various embodiments, if a click-through is not received, the implementation can continuously loop back to itself with respect to a web page. In other words, no change occurs until a click-through. In another implementation, a new advertisement can be displayed. In still another implementation, other techniques, such as dynamic actions, can be deployed to capture a user's attention (e.g., advertisement can move around web page, or start flashing in contrasting colors).

FIG. 2 is a flow chart illustrating a method 120 for selecting online advertisements based on tagging in accordance to an embodiment.

At step 210, a first advertisement is displayed on a web page. A user can spawn a web browser and input a URL (Uniform Resource Locator), such as http://www.yahoo.com. The web browser can be a software application, such as Internet Explorer or Mozilla Firefox, for accessing information on the World Wide Web. The web browser then loads a web page. The web page displays the advertisement associated with the URL to the user. Further, the user can navigate through different web pages by accessing the hypertext links. As the user navigates, multiple advertisements are displayed. The web page is, in one example, is a document consisting of text, images, advertisements and hypertext links. The web page can be implemented in any suitable format, such as a Hypertext markup language (HTML), Hypertext Preprocessor (PHP), Flash, and the like.

An advertisement can be text, an image, video or animation related to, for example, a product or service. In one embodiment, the advertisement can be a click-through to a new web page displaying more detailed information. The advertisement can be located in a static position, or dynamically move across the web page. In targeted advertising, the advertisement is selected from a group of possible advertisements based on information deduced about the user such as the content web page, user age, user location, browser search history, time until an event, and the like.

In one embodiment, an advertisement is supplemented with a tagging mechanism. In one embodiment, one or more buttons or check boxes are provided for user selection (e.g., “Like” button or a number of stars). In another embodiment, a text box is provided for user-generated tags. The tagging mechanism can be continuously displayed, or pop-up responsive to a cursor hovering over the advertisement. In an embodiment, a user can browse through a web page of advertisements, offering feedback on multiple advertisements at once.

At step 220, an advertisement tag is received from the user. The tag is input by a user and sent by a client across a network. In some embodiments, tags are further processed before being used for matching. The tags may be codes that need to be translated to search terms. The tags may be specific terms that need to be generalized to get more matches when searched. Many other embodiments are possible.

At step 230, a second advertisement is selected based on the tag. In one embodiment, a user history of tags is complied, allowing subsequent advertisements to be selected from several tags. A user can be identified by log-on credentials, IP (Internet Protocol) addresses, and the like.

The specific technique for selecting an advertisement is implementation-specific. In one implementation, tags received from users are matched against metadata associated with advertisements in a pool. One or more advertisements are returned for display. A list can be ranked according to relevance or any other suitable parameters. In another embodiment described with respect to FIG. 4a and FIG. 4B, a bipartite graph is used to recommend advertisements for a specific user, taking into account click-through rates (CTRs).

At step 240, the second advertisement is displayed to the user. For example, an advertisement that ranked highest in relevance can be displayed. The remaining list can be queued for display later. In one embodiment, more than one advertisement is displayed at a time. The queue can also be updated based on new tags received from newly displayed advertisements.

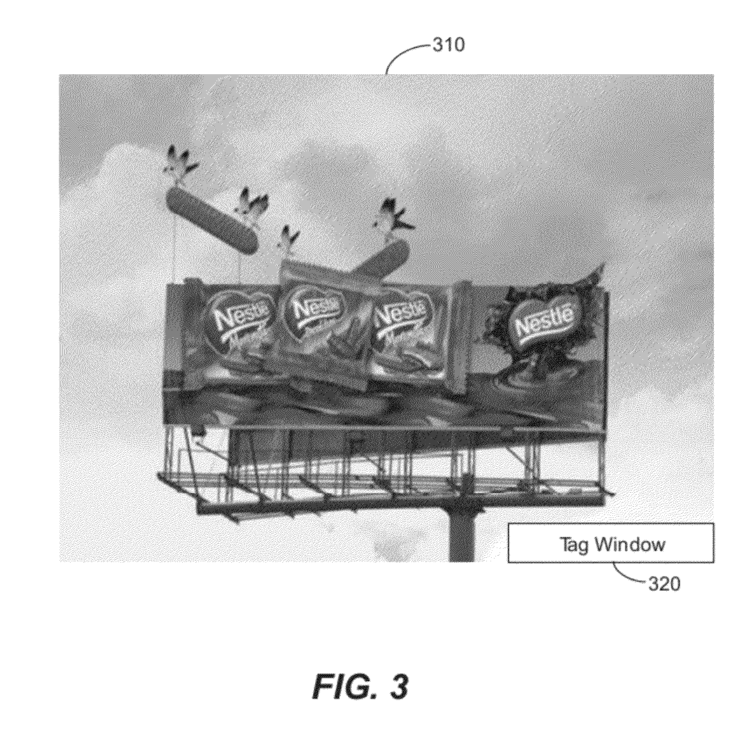

FIG. 3 is a schematic representation illustrating exemplary advertisement 310 with a tag window 320 in accordance with an embodiment. The advertisement 310 can be displayed in any digital environment such as a web page, a video game, a video, or the like.

FIG. 4A is a bipartite graph 405 in accordance to an embodiment. The bipartite graph 405 is a graph with vertices divided into two disjoint sets and one or more edges are used to connect the two disjoint sets. The bipartite graph 405 includes users and advertisement clusters as vertices and edges as click through rate (CTR) for the corresponding pair of vertices (user—ad cluster). In the bipartite graph 405, a, b, c, d, e are exemplary representations of a plurality of users and A, B, C, D, E, F are exemplary representations of a plurality of advertisement clusters. Each edge has a weight that signifies the average CTR for the corresponding user-ad cluster pair. The CTR for a non-existing pair with no edges is assumed to be “zero”. For example, the pair of vertices (c,B) has no edge between them and hence the CTR for (c, B) is “zero”.

FIG. 4B is a matrix AD 420 representing the weighted edges in the bipartite graph 405 with “i” columns and “j” rows. The “i” columns represents users and “j” rows represents the advertisement clusters. The (i, j) th value signifies the CTR for the corresponding pair of user and advertisement cluster.

A first Ad-Ad similarity matrix AA1(i,j) is created where each value in the matrix represents the correlation between advertisement clusters (i, j). The value in the matrix AA1 is based on the values of rows i and j of matrix AD. The matrix AA1 represents the similarity between the advertisement clusters present in the matrix AD based on the CTR. The matrix AA1 can also be used to obtain advertisements based on the interest of a website publisher since higher CTR corresponds to higher revenue to the website publisher.

A tag matrix T with i rows and j columns is created. The rows represent the advertisement clusters and columns represent the advertisement tags. The (i,j)th entry in the tag matrix T represents the frequency of a particular advertisement tag within a particular advertisement cluster.

A second Ad-Ad similarity matrix AA2(i,j) is created where each value in the matrix represents the correlation between the advertisement clusters and the advertisement tags of the tag matrix T. Matrix AA2(i,j) can be used to capture advertisements based on the interest of the users since advertisement tags are generated by the users.

Finally, a similarity matrix AA(i,j) is generated from combining the first Ad-Ad similarity matrix AA1(i,j) and the second Ad-Ad similarity matrixAA2(i,j). The matrix AA(i,j) is generated by applying a combined function, for example, weighted sum, of matrices AA1 and AA2. The combined function is illustrated as below:

AA(i,j)=F(AA1(i,j),AA2(i,j))

Further, if the function F is weighted sum, then the combined function can be illustrated as below:

AA(i,j)=_∝(AA1(i,j)+_{—}βAA2(i,j))

where ∝ and β are weights suitably chosen by the publisher.

To recommend an advertisement for a user “u”, the numbers corresponding to the highest “k” values in column “u” of matrix AD are selected. Similarly, the highest “c” values in each row in matrix AA corresponding to the above row numbers are selected. “k” and “c” are constants suitably chosen by the advertisement publisher. The product “k*c” gives the number of ad clusters chosen. The ad clusters are then filtered and ranked to display the recommended advertisement to the user.

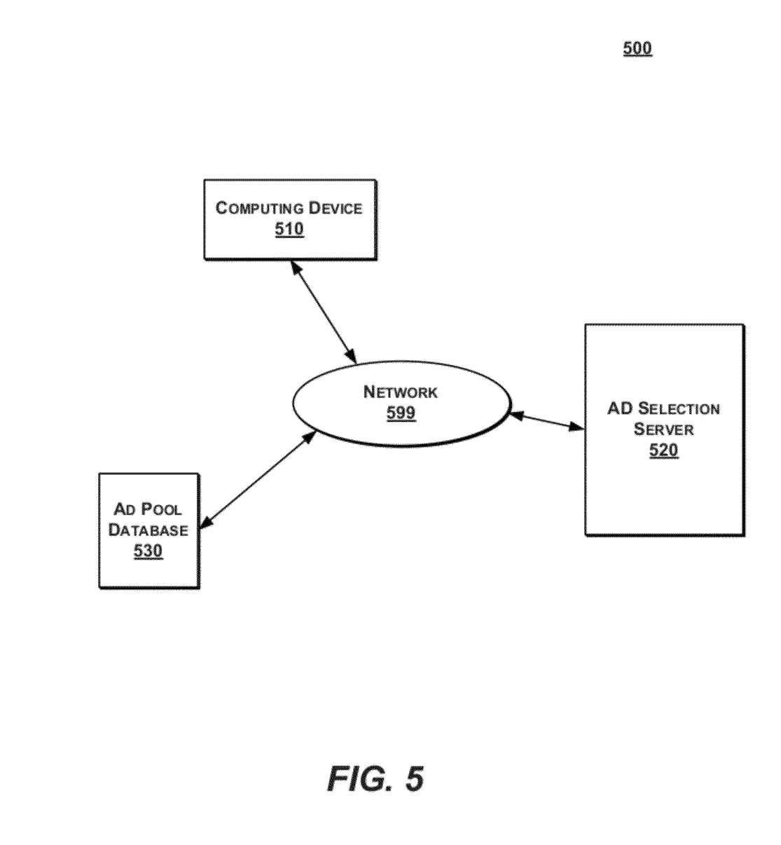

FIG. 5 is a block diagram illustrating a system 600 to display online advertisement based on tagging according to an embodiment. The system 500 can implement methods discussed above. The system 500 includes a computing device 510, an ad selection server 520, and an ad pool database 530 coupled in communication through a network 599 (e.g., the Internet or a cellular network).

The computing device 510 can be, for example, a PC, a stationary computing device, a laptop or notebook computer, a tablet computer, a smart phone or PDA, a smart appliance, a video gaming console, an Internet television, a set-top box, or any other suitable processor-based device that can send view advertisements. There can be numerous computing devices 510 used by different users. In one embodiment, the computing device 510 displays advertisements selected in response to tagging. Additional embodiments of the computing device 510 are described in more detail below.

The ad selection server 520 can be one or more of any of the above processor-based devices. In one embodiment, the ad selection server 520 selects one or more advertisements to be displayed to a user responsive to tagging. Additional embodiments of the ad selection server 520 are described in more detail below.

The ad pool database 530 can be one or more of any of the above processing-based devices. In one embodiment, the ad pool database 530 stores digital advertisements and interfaces with the ad selection server 530 for downloading advertisements to clients.

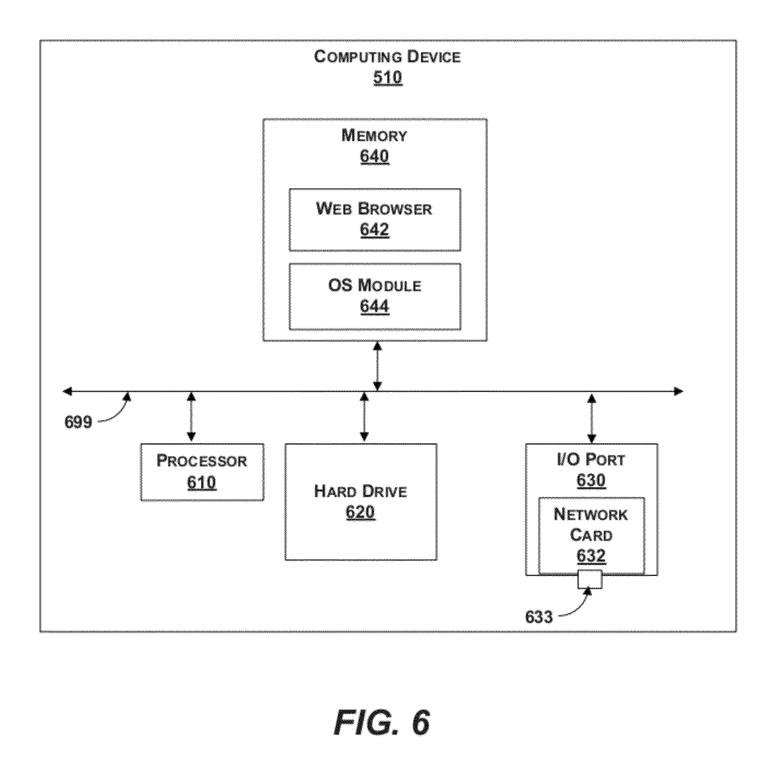

FIG. 6 is a block diagram illustrating an exemplary computing device 510 according to one embodiment. The computing device 510 includes a processor 610, a hard drive 620, an I/O port 630, and a memory 640 coupled by a bus 699.

The bus 699 can be soldered to one or more motherboards. The processor 610 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 610 is specially suited for the processing demands of displaying advertisements (e.g., custom micro-code, instruction fetching, pipelining or cache sizes). The processor 610 can be disposed on silicon or any other suitable material. In operation, the processor 610 can receive and execute instructions and data stored in the memory 640 or the hard drive 620. The hard drive 620 can be a platter-based storage device, a flash drive, an external drive, a persistent memory device, or any other type of memory.

The hard drive 620 provides persistent (i.e., long term) storage for instructions and data. The I/O port 620 is an input/output panel including a network card 632. The network card 632 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 633 is configured according to networking compatibility. For example, a wired networking card includes a physical port to plug in a cord, and a wireless networking card includes an antennae. The network card 632 provides access to a communication channel on a network.

The memory 640 can be a RAM (Random Access Memory), a flash memory, a non-persistent memory device, or any other device capable of storing program instructions being executed. The memory 640 further comprises a web browser 642, and an OS (operating system) module 644. The OS module 644 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 642 can be a desktop web browser (e.g., Internet Explorer, Mozilla, or Chrome), a mobile browser, or a web viewer built integrated into an application program. In an embodiment, a user accesses a system on the World Wide Web (WWW) through a network such as the Internet. The web browser 642 is used to download web pages or other content in various formats including HTML, XML, text, PDF, and postscript, and may be used to upload information to other parts of the system. The web browser 642 may use URLs to identify resources on the web and HTTP (HyperText Transfer Protocol) in transferring files on the web. The web page can also include advertisement selected as described herein.

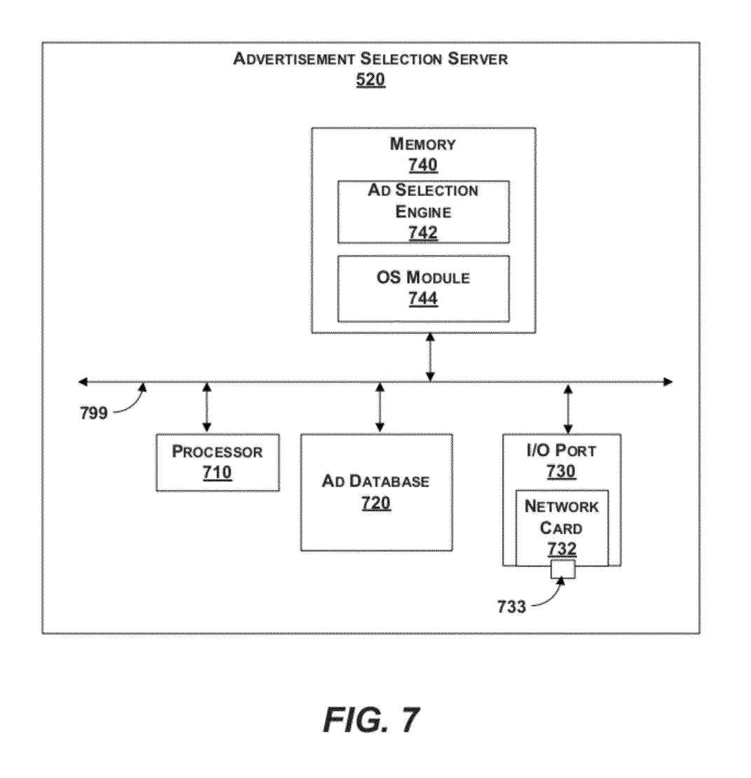

FIG. 7 is a block diagram illustrating an exemplary ad selection server 530 according to one embodiment. The ad selection server 530 includes a processor 710, an advertisement database 720, an I/O port 730, and a memory 740, coupled by a bus 799. The processor 710, the advertisement database 720, and the I/O port 730 can be configured as described above with respect to FIG. 6.

The memory 740 comprises an OS module 744, as described above, along with an ad selector engine 742. The ad selection engine 742 can select an advertisement from the ad pool database 530 of FIG. 5. The ad selector engine 742 is described in more detail below.

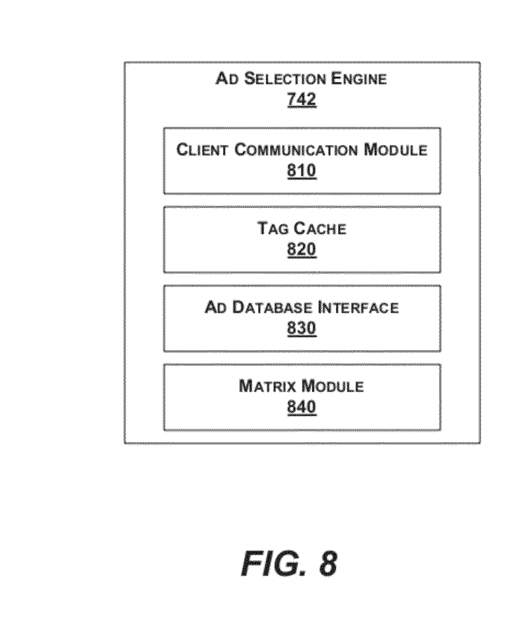

FIG. 8 is a block diagram illustrating an exemplary ad selection engine 742 according to one embodiment. The ad selection engine 842 includes a client communication module 810, a tag cache 820, an ad database interface 830 and a matrix module 840 The components can communicate with each other through, for example, APIs (Application Programming Interfaces). In other embodiments, all or parts of the components can be implemented in hardware or benefit from special hardware accelerators.

The client communication module 810 communicates with, for example, the computing device 510 (or an installed client) to receive tags and send advertisements. The tag cache 820 stores tags associated with a user. The ad database interface 830 communicates with the ad pool database 530 for searching advertisements and directing advertisements to be downloaded to clients.

As described herein, computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for providing online advertisements based on tagging, comprising:
displaying a first advertisement on a web page;
receiving an advertisement tag from a user, the advertisement tag comprising a description of the first advertisement;
selecting a second advertisement based on the advertisement tag; and
displaying the second advertisement.

2. The method of claim 1 further comprising:
separating a plurality of advertisements into clusters based on metadata associated with each of the plurality of advertisements.

3. The method of claim 2, wherein selecting the second advertisement comprises comparing the advertisement data to the metadata.

4. The method of claim 2, wherein selecting the second advertisement comprises calculating a correlation between each of the clusters and a particular user.

5. The method of claim 1, wherein selecting the second advertisement comprises selecting the second advertisement based on a combination of the advertisement tag and a click-though.

6. The method of claim 1, wherein the advertisement tag comprises a plurality of advertisement tags associated with a plurality of advertisements, each advertisement having one or more associated advertisement tags included in the plurality of advertisement tags.

7. The method of claim 1 further comprising:
prior to receiving the advertisement tag, identifying the user with a log-on.

8. The method of claim 1, wherein selecting the second advertisement comprises selecting the second advertisement without using passively observed information that is not explicitly related to the first advertisement.

9. A computer program product stored on a non-transitory computer-readable medium that when executed by a processor, performs a method for providing online advertisements based on tagging, comprising:
displaying a first advertisement on a web page;
receiving an advertisement tag from a user, the advertisement tag comprising a description of the first advertisement;
selecting a second advertisement based on the advertisement tag; and
displaying the second advertisement.

10. The method of claim 9 further comprising: separating a plurality of advertisements into clusters based on metadata associated with each of the plurality of advertisements.

11. The method of claim 10, wherein selecting the second advertisement comprises comparing the advertisement data to the metadata.

12. The method of claim 10, wherein selecting the second advertisement comprises calculating a correlation between each of the clusters and a particular user.

13. The method of claim 9, wherein selecting the second advertisement comprises selecting the second advertisement based on a combination of the advertisement tag and a click-though.

14. The method of claim 9, wherein the advertisement tag comprises a plurality of advertisement tags associated with a plurality of advertisements, each advertisement having one or more associated advertisement tags included in the plurality of advertisement tags.

15. The method of claim 9 further comprising:
prior to receiving the advertisement tag, identifying the user with a log-on.

16. The method of claim 9, wherein selecting the second advertisement comprises selecting the second advertisement without using passively observed information that is not explicitly related to the first advertisement.

17. A system to provide online advertisements based on tagging, the system comprising:
a web interface to display an first advertisement on a web page, the web interface receiving an advertisement tag from a user, the advertisement tag comprising a description of the first advertisement; and
an advertisement selection engine, communicatively coupled to the web interface, the advertisement selection engine to select a second advertisement based on the advertisement tag,
wherein the web interface displays the second advertisement.

18. The system as claimed in claim 17, wherein the advertisement selection engine separates a plurality of advertisements into clusters based on metadata associated with each of the plurality of advertisements.

19. The system as claimed in claim 18, wherein the advertisement selection engine compares the advertisement data to the metadata.

20. The system as claimed in claim 18, wherein the advertisement selection engine also calculates a correlation between each of the clusters and a particular user.
